(19) United States
(12) Patent Application Publication
(10) Pub. No.: US 2023/0237125 A1
(43) Pub. Date: Jul. 27, 2023

(54) METHOD, ELECTRONIC DEVICE, AND COMPUTER PROGRAM PRODUCT FOR PROCESSING DATA

(71) Applicant: Dell Products L.P., Round Rock, TX (US)

(72) Inventors: Wenbin Yang, Shanghai (CN); Jiacheng Ni, Shanghai (CN); Zijia Wang, WeiFang (CN); Zhen Jia, Shanghai (CN)

(21) Appl. No.: 17/687,294

(22) Filed: Mar. 4, 2022

(30) Foreign Application Priority Data
Jan. 21, 2022 (CN) 202210072585.2

(51) Int. Cl. G06K 9/62

(52) U.S. Cl. CPC G06K 9/6251; G06K 9/6255

(57) ABSTRACT

Embodiments of the present disclosure relate to a method, an electronic device, and a computer program product for processing data. The method includes determining a reference tensor based on a tensor representing multidimensional data, where the reference tensor is associated with a target tensor. The method further includes decomposing the reference tensor to obtain multiple low-rank tensors, where a rank of each of the low-rank tensors is lower than that of the reference tensor. The method further includes determining the target tensor based on the multiple low-rank tensors so as to determine multidimensional data at a specific moment. By means of embodiments of the present disclosure, the overhead of computing resources may be reduced, and the time for processing data may be reduced.

### RELATED APPLICATION(S)

The present application claims priority to Chinese Patent Application No. 202210072585.2, filed Jan. 21, 2022, and entitled “Method, Electronic Device, and Computer Program Product for Processing Data,” which is incorporated by reference herein in its entirety.

### FIELD

Embodiments of the present disclosure relate to the field of computers, and more specifically, to a method, an electronic device, an apparatus, a medium, and a computer program product for processing data.

### BACKGROUND

With improvement of processing capabilities of computing resources, when facing problems of processing multidimensional data, there are corresponding methods which can consider data from multiple dimensions simultaneously for processing, such as merging data from multiple dimensions. As a more particular example, when facing a problem of predicting a traffic flow, weather, week, holiday, time, and real-time road status from cameras may be considered simultaneously. In the prior art, a typical method involves representing these multidimensional data by tensors. However, such conventional approaches tend to make ranks of the tensors relatively high, which in turn makes it difficult to meet requirements using processing capabilities of existing computing resources. Therefore, a data processing method for processing high-rank tensors is needed to reduce overhead of computing resources and time for processing the multidimensional data.

### SUMMARY

Embodiments of the present disclosure provide a method, an electronic device, an apparatus, a medium, and a computer program product for processing data.

According to a first aspect of the present disclosure, a method for processing data is provided. The method includes determining a reference tensor based on a tensor representing multidimensional data, where the reference tensor is associated with a target tensor. The method further includes decomposing the reference tensor to obtain multiple low-rank tensors, where a rank of each of the low-rank tensors is lower than that of the reference tensor. The method further includes determining the target tensor based on the multiple low-rank tensors so as to determine multidimensional data at a specific moment.

According to a second aspect of the present disclosure, an electronic device is provided. The electronic device includes a processor and a memory coupled to the processor, and the memory has instructions stored therein which, when executed by the processor, cause the device to execute actions including determining a reference tensor based on a tensor representing multidimensional data, where the reference tensor is associated with a target tensor. The actions further include decomposing the reference tensor to obtain multiple low-rank tensors, where a rank of each of the low-rank tensors is lower than that of the reference tensor. The actions further include determining the target tensor based on the multiple low-rank tensors so as to determine multidimensional data at a specific moment.

According to a third aspect of the present disclosure, an apparatus for processing data is provided. The apparatus includes a reference tensor determining module configured to determine a reference tensor based on a tensor representing multidimensional data, where the reference tensor is associated with a target tensor. The apparatus further includes a tensor decomposition module configured to decompose the reference tensor to obtain multiple low-rank tensors, where a rank of each of the low-rank tensors is lower than that of the reference tensor. The apparatus further includes a multidimensional data determining module configured to determine the target tensor based on the multiple low-rank tensors so as to determine multidimensional data at a specific moment.

According to a fourth aspect of the present disclosure, a computer-readable storage medium is provided. The computer-readable storage medium includes machine-executable instructions, where the machine-executable instructions, when executed by a device, cause the device to execute the method according to the first aspect of the present disclosure.

According to a fifth aspect of the present disclosure, a computer program product is provided. The computer program product is tangibly stored on a computer-readable medium and includes machine-executable instructions, where the machine-executable instructions, when executed by a device, cause the device to execute the method according to the first aspect of the present disclosure.

This Summary is provided to introduce the selection of concepts in a simplified form, which will be further described in the Detailed Description below. The Summary is neither intended to identify key features or essential features of the claimed subject matter, nor intended to limit the scope of the claimed subject matter.

### BRIEF DESCRIPTION OF THE DRAWINGS

The above and other features, advantages, and aspects of embodiments of the present disclosure will become more apparent in conjunction with the accompanying drawings and with reference to the following detailed description. In the accompanying drawings, identical or similar drawing marks represent identical or similar elements, in which:

FIG. 1 is a block diagram of an example environment according to some embodiments of the present disclosure;

FIG. 2 is a schematic diagram of generating a tensor representing multidimensional data according to some embodiments of the present disclosure;

FIG. 3 is a flowchart of a method for processing data according to some embodiments of the present disclosure;

FIG. 4 is a block diagram of an apparatus for processing data according to some embodiments of the present disclosure; and

FIG. 5 is a schematic block diagram of an example device for implementing some embodiments according to the present disclosure.

In all the accompanying drawings, identical or similar reference numerals indicate identical or similar elements.

### DETAILED DESCRIPTION

Example embodiments of the present disclosure will be described in more detail below with reference to the accompanying drawings. Although the drawings show some embodiments of the present disclosure, it should be understood that the present disclosure can be implemented in various forms, and should not be explained as being limited to the embodiments stated herein. Instead, these embodiments are provided for understanding the present disclosure more thoroughly and completely. It should be understood that the accompanying drawings and embodiments of the present disclosure are merely for exemplary purposes, and are not used to limit the protection scope of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In addition, all the specific numerals are examples, are merely for facilitating understanding, and are not intended to limit scopes at all.

Even if processing capabilities of computing resources are highly improved, when processing problems related to multidimensional data, the problems are often beyond the processing capabilities. This is because in conventional cases, a method for processing multidimensional data is to first determine a tensor representing the multidimensional data. Therefore, when a rank of the tensor is relatively high and beyond the processing capabilities of current computing resources or time for processing the tensor is unacceptable, the conventional method is unfeasible. Therefore, a method for processing data of high-rank tensors is needed to reduce overhead of computing resources and time for processing data.

In view of this, the present disclosure provides a method for processing data. It can be understood by means of the following description that compared with a known conventional method, in the method of the present disclosure, a tensor representing multidimensional data may be decomposed to obtain multiple low-rank tensors, and multidimensional data at a specific moment (for example, determining a certain future moment) is determined in this manner. In this way, computing resources may meet the capability for processing low-rank tensors, and processing time may be reduced. Therefore, the working principle and mechanism of the present disclosure are significantly different from any known methods.

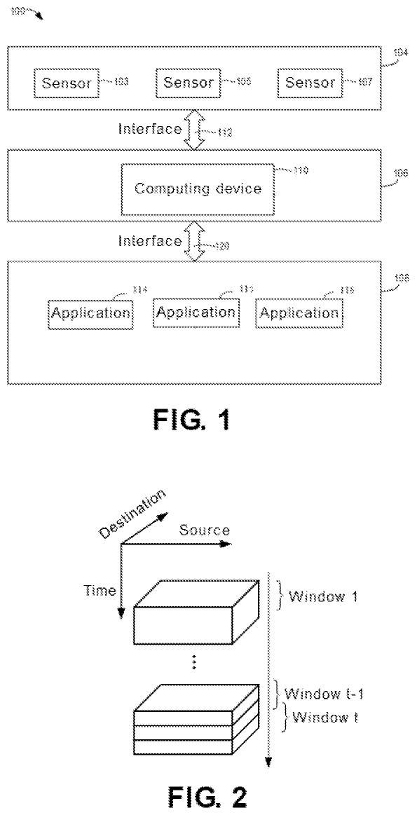

FIG. 1 is a block diagram of example environment 100 according to some embodiments of the present disclosure.

In layer 104, data from sensors (e.g., sensors 103, 105, and/or 107) or devices are obtained to form multidimensional data. For example, in a traffic scene, road status information from cameras, unexpected events of a certain road section, holidays, and the like may be included. For another example, in a network scene, bytes on network channels, a structure of a network and the like may be included. In layer 104, a tensor representing multidimensional data may also be generated, for example, by using Hadoop.

In layer 106, which communicates with layer 104 via interface 112, computing device 110 obtains a tensor representing multidimensional data, determines a reference tensor based on said tensor, and decomposes the reference tensor to obtain multiple low-rank tensors, where a rank of each of the low-rank tensors is lower than that of the reference tensor. A target tensor is determined based on the multiple low-rank tensors so as to determine multidimensional data at a specific moment. For example, for a traffic flow, a traffic jam condition within a future period may be determined. For another example, for a software-defined networking (SDN) network flow, a change condition of the network flow within a future period may be determined.

In layer 108, which communicates with layer 106 via interface 120, an application (e.g., application 114, 115, and/or 116) receives the determined multidimensional data at the specific moment for executing subsequent required processing.

It should be understood that example environment 100 shown in FIG. 1 is exemplary only and is not intended to limit the scope of the present disclosure. Various additional devices, apparatuses, and/or modules may also be included in example environment 100. Moreover, the modules shown in FIG. 1 are also only illustrative and are not intended to limit the scope of the present disclosure. In some embodiments, certain modules may be integrated into one physical entity, or may further be split into more modules.

In the following description, some embodiments will be discussed by referring to a flow in an SDN network. However, it should be understood that this is only for a better understanding of the principles and ideas of embodiments of the present disclosure, and is not intended to limit the scope of the present disclosure in any way.

It can be understood that in an SDN network, a flow table stores important data, including all network devices and their topology information, such as source Internet Protocol (IP) addresses, source ports, routing information, destination IP addresses, protocols, etc. Therefore, flow statistical data in the SDN network is a kind of multimodal and multidimensional data. The multidimensional data may be organized as a tensor.

As stated above, multidimensional data may be represented as a tensor. For ease of understanding, in some description herein, a vector may be considered as one-dimensional data, a matrix may be considered as two-dimensional data, and a tensor may be considered as three-dimensional data or above.

FIG. 2 is a schematic diagram of generating a tensor representing multidimensional data according to some embodiments of the present disclosure.

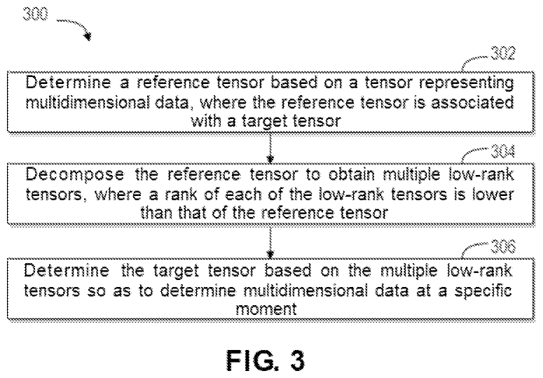

The process shown in FIG. 2 may occur at layer 104 or other places, which is not limited by the present disclosure. An exemplary tensor has three dimensions, i.e., source, destination, and time, and a series of tensors representing the flow in an SDN network may be obtained as time elapses. That is, tensors are generated based on moving time windows. For example, the flow statistical data of time window 1 is used to generate a first tensor, . . . , the flow statistical data of time window t−1 is used to generate a (t−1)th tensor, and the flow statistical data of time window t is used to generate a t-th tensor. Here, these time windows may have the same number of time slices, for example, 10, 20, 30, or 50 time slices. In some description herein, a duration of a time window, i.e., the number of time slices included in a time window, may also be called a slice length. In addition, as shown in FIG. 2, two adjacent tensors may have overlapped time slices. For example, the last one or more time slices of the (t−1)th tensor also belong to the t-th tensor. FIG. 3 is a flowchart of method 300 for processing data according to some embodiments of the present disclosure.

In block 302, a reference tensor is determined based on a tensor representing multidimensional data, where the reference tensor is associated with a target tensor.

In some embodiments, the reference tensor is associated with a previous moment (i.e., t−1) relative to specific moment t, and the target tensor indicates a tensor at time window t.

In block 304, the reference tensor is decomposed to obtain multiple low-rank tensors, where a rank of each of the low-rank tensors is lower than that of the reference tensor.

As an example, the reference tensor may be decomposed in the following manner, and how to perform tensor train decomposition is stated below.

It can be understood that for a matrix, singular value decomposition is known. In a form of tensor-matrix product, singular value decomposition may be represented as:

M=Σx₁Ux₂V (1)

where matrix Σ represents a diagonal matrix, and matrixes U and V represent orthogonal matrixes, where operators x₁ and x₂ respectively represent matrix products about a first dimension (row) and a second dimension (column) of a matrix. Diagonal matrix Σ obtained by singular value decomposition may be understood as a general description of original matrix M, for example, it can be used for data compression and feature extraction of original matrix M.

In some description herein, decomposition of higher dimensions will be used, and the decomposition may be represented as a tensor train decomposition:

[symbol]

(i₁,i₂, . . . ,i_{d})= [symbol] ₁(:,i₁,:) [symbol] ₂(:,i₂,:) . . . [symbol] _{d}(:,i_{d},:) (2)

where [symbol] represents a decomposed original tensor having d dimensions, [symbol] ∈ [symbol] ^{I}^{₁}^{×I}^{₂}^{× . . . I}^{_{d}}; Iₖ represents a data size of the k-th dimension; [symbol] ₁ represents a low-rank tensor decomposed by using the first dimension; [symbol] ₂ represents a low-rank tensor decomposed by using the second dimension; and [symbol] _{d} represents a low-rank tensor decomposed by using the d-th dimension. Each [symbol] ₖ (where (k=[1, d])) is called a core tensor of tensor train decomposition.

In some embodiments, a first function is determined based on the multiple low-rank tensors within a first time period prior to the specific moment, where the first function indicates a relationship between the determined target tensor and the reference tensor.

As an example, the following description provides a state-observation model, which allows for modeling of dynamic features of tensors, and a first function may be determined by means of the following formulas:

State model

[symbol]

(t)=ƒ( [symbol] (t−1), . . . , [symbol] (t−P))+ [symbol] (t) (3)

Observation model

[symbol]

(t)=g( [symbol] (t))+ [symbol] (t) (4)

where P>0 represents an order of the state model; [symbol] (t) represents a tensor at moment t; [symbol] (t−1) represents a tensor at moment t−1; ƒ represents a conversion function and may be represented as a linear function or a non-linear function; [symbol] (t) represents a tensor observed at moment t; g represents an observation function and may be represented as a linear function or a non-linear function; and [symbol] (t) and [symbol] (t) respectively represent state noise and observation noise.

Thus, based on the state-observation model, formula (3) may be used to determine the first function. Formula (4) may be used to update the first function. As an example, when P=1, [symbol] (t−1) represents a reference tensor, an interval between t and t−1 may represent the first time period, and ƒ represents a relationship between the target tensor and the reference tensor.

In some embodiments, train decomposition may be performed on the reference tensor by using a predetermined decomposition factor to generate at least two low-rank tensors, and the target tensor may also be determined by using the at least two low-rank tensors.

As an example, formula (2) in the above description may be used to decompose the reference tensor to obtain at least two low-rank tensors.

In some embodiments, a second function may be determined based on a difference between the determined target tensor and an actually obtained target tensor within the first time period. The second function may also be minimized, and a parameter of the second function is updated during minimization of the second function.

As an example, the second function may be determined by means of autoregression, the second function is determined by using the following formula, and the second function is minimized.

$${min}_{𝒯} E ( {‖ 𝒵 ( t ) - 𝒳 ( t ) ‖}_{F} ) \\ \begin{matrix}s . t . 𝒵 ( t ) = {\sum }_{p = 1}^{P} {𝒯}_{P} \times \begin{matrix}\{ 1 , 2 , … , d \} \\ \{ 1 , 2 , … , d \}\end{matrix} 𝒳 ( t - p ) \\ = 𝒯 \times \begin{matrix}\{ 1 , 2 , … , d , 2 d + 1 \} \\ \{ 1 , 2 , … , d , + 1 \}\end{matrix} {𝒳}_{s} ( t )\end{matrix} \qquad ( 5 )$$

where [symbol] (t) represents estimation of the target tensor at moment t; ∥ ∥F represents a Frobenius norm; E represents an operational symbol determining an Einstein product; d represents a dimension of the tensor; [symbol] =[ [symbol] ] and P=2d+1; and [symbol] ₛ represents a normalized tensor of [ [symbol] (t−1), [symbol] (t−2), . . . , [symbol] (t−P)] at moment t. It can be understood that [symbol] (t)− [symbol] (t) may represent the difference between the determined target tensor and the actually obtained target tensor.

In some embodiments, a decomposition factor may be updated by using the updated parameter of the second function.

In some embodiments, a Frobenius norm may be determined based on a difference between the determined target tensor and the actually obtained target tensor; and an Einstein product of the Frobenius norm may also be determined as the second function. As an example, E(∥ [symbol] (t)− [symbol] (t)∥_{F}) represents the determined Einstein product of the Frobenius norm.

In some embodiments, a nuclear norm associated with the reference tensor may be determined as an additional part of the second function. As an example,

$$λ {\sum }_{k = 1}^{d + 1} {‖ {U}_{k} ‖}_{*}$$

may be used to represent the nuclear norm associated with the reference tensor.

Meanwhile, considering that direct computation of formula (5) may cause relatively high overhead of computing resources, the following formula (6) may also be used to minimize the second function.

$${min}_{{U}_{k}} E ( {‖ 𝒵 ( t ) - 𝒳 ( t ) ‖}_{F} ) + λ {\sum }_{k = 1}^{d + 1} {‖ {U}_{k} ‖}_{*} \\ s . t . {𝒥}_{k} ( t ) = {U}_{k} \times \begin{matrix}1 \\ 2\end{matrix} {𝒥}_{k} ( t ) k = 1 , … , d + 1 \\ 𝒵 ( t ) = {𝒥}_{1} ( t ) {𝒥}_{2} ( t ) ⋯ {𝒥}_{d + 1} ( t ) \qquad ( 6 )$$

where k=1, 2, . . . , d+1; Uₖ represents the k-th filtering tensor of the low-rank tensor, and filtering can be based on a Bayesian filter; ∥ ∥_{*} represents the nuclear norm; λ represents a parameter; [symbol] represents an intermediate tensor; and

$${U}_{k} \times \begin{matrix}1 \\ 2\end{matrix} {𝒥}_{k} ( t )$$

represents addition of the first dimension of filtering tensor U and the second dimension of intermediate tensor [symbol] .

In some embodiments, a decomposition factor is determined based on the parameter of the second function during minimization, and a target tensor is determined based on the decomposition factor so as to simplify computation of an original high-rank tensor (for example, a tensor directly generated for expressing multidimensional data), thereby reducing computation overhead and saving computation time.

At block 306, the target tensor is determined based on the multiple low-rank tensors so as to determine multidimensional data at a specific moment. As an example, the target tensor may be determined by using the reference tensor before specific moment t, and the target tensor represents multidimensional data at moment t.

In this way, the decomposed low-rank tensor may be used to avoid direct processing of high-rank tensors, thereby determining the target tensor more conveniently and easily and quickly predicting the multidimensional data at a specific moment by using the target tensor. In this way, the overhead of computing resources can be reduced, and the time for processing data can be saved.

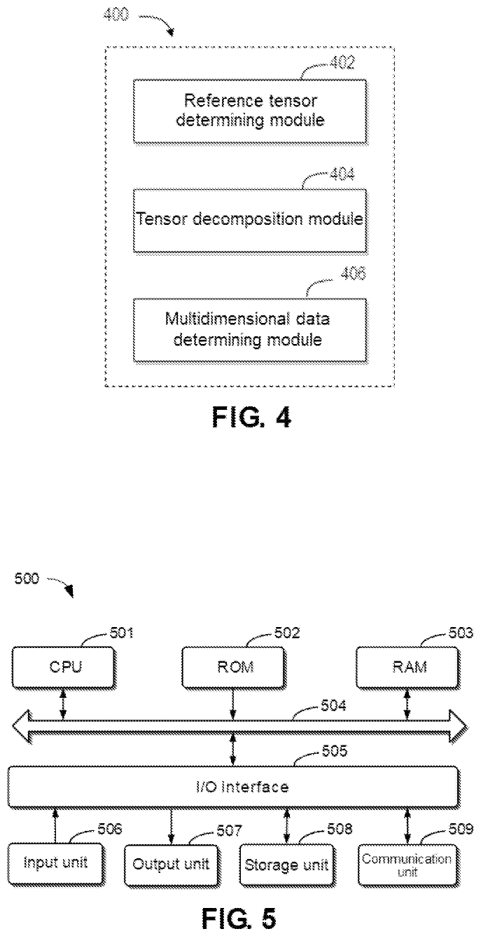

FIG. 4 is a block diagram of apparatus 400 for processing data according to some embodiments of the present disclosure.

Reference tensor determining module 402 is configured to determine a reference tensor based on a tensor representing multidimensional data, where the reference tensor is associated with a target tensor.

Tensor decomposition module 404 is configured to decompose the reference tensor to obtain multiple low-rank tensors, where a rank of each of the low-rank tensors is lower than that of the reference tensor.

Multidimensional data determining module 406 is configured to determine the target tensor based on the multiple low-rank tensors so as to determine multidimensional data at a specific moment.

In some embodiments, determining the target tensor includes determining a first function based on the multiple low-rank tensors within a first time period prior to the specific moment, where the first function indicates a relationship between the determined target tensor and the reference tensor.

In some embodiments, decomposing the reference tensor to obtain multiple low-rank tensors includes performing train decomposition on the reference tensor by using a predetermined decomposition factor to generate at least two low-rank tensors; and determining the target tensor by using the at least two low-rank tensors.

In some embodiments, tensor decomposition module 404 is further configured to determine a second function based on a difference between the determined target tensor and an actually obtained target tensor within the first time period, minimize the second function, and update a parameter of the second function during minimization of the second function.

In some embodiments, determining a second function includes determining a Frobenius norm based on a difference between the determined target tensor and the actually obtained target tensor, and determining an Einstein product of the Frobenius norm as the second function.

In some embodiments, tensor decomposition module 404 is further configured to determine a nuclear norm associated with the reference tensor as an additional part of the second function.

It can be understood that, by processing data by means of above-described apparatus 400, a problem that high-rank tensors cannot be directly processed can be solved, and moreover, multidimensional data at a specific moment can be predicted by using low-rank tensors obtained by decomposing the high-rank tensors. Thus, the demand for computing resources may be reduced, and the speed of processing data may be improved. Therefore, apparatus 400 may also provide at least one of method 300 and other preceding advantages.

FIG. 5 is a schematic block diagram of device 500 that may be configured to implement embodiments of the present disclosure. Device 500 may be an electronic device described in embodiments of the present disclosure. As shown in FIG. 5, device 500 includes central processing unit (CPU) 501 which may perform various appropriate actions and processing according to computer program instructions stored in read-only memory (ROM) 502 or computer program instructions loaded from storage unit 508 to random access memory (RAM) 503. Various programs and data required for the operation of device 500 may also be stored in RAM 503. CPU 501, ROM 502, and RAM 503 are connected to each other through bus 504. Input/output (I/O) interface 505 is also connected to bus 504. Although not shown in FIG. 5, device 500 may also include a coprocessor.

A plurality of components in device 500 are connected to I/O interface 505, including: input unit 506, such as a keyboard and a mouse; output unit 507, such as various types of displays and speakers; storage unit 508, such as a magnetic disk and an optical disc; and communication unit 509, such as a network card, a modem, and a wireless communication transceiver. Communication unit 509 allows device 500 to exchange information/data with other devices via a computer network, such as the Internet, and/or various telecommunication networks.

The various methods or processes described above may be performed by CPU 501. For example, in some embodiments, the method may be implemented as a computer software program that is tangibly included in a machine-readable medium, such as storage unit 508. In some embodiments, part of or all the computer program may be loaded and/or installed to device 500 via ROM 502 and/or communication unit 509. When the computer program is loaded into RAM 503 and executed by CPU 501, one or more steps or actions of the methods or processes described above may be executed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device capable of retaining and storing instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flowcharts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flowcharts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flowcharts and/or block diagrams.

The flowcharts and block diagrams in the drawings illustrate the architectures, functions, and operations of possible implementations of the devices, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two consecutive blocks may in fact be executed substantially concurrently, and sometimes they may also be executed in a reverse order, depending on the functions involved. It should be further noted that each block in the block diagrams and/or flowcharts as well as a combination of blocks in the block diagrams and/or flowcharts may be implemented using a dedicated hardware-based system that executes specified functions or actions, or using a combination of special hardware and computer instructions.

Various embodiments of the present disclosure have been described above. The foregoing description is illustrative rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments or the technical improvements to technologies on the market, so as to enable other persons of ordinary skill in the art to understand the embodiments disclosed herein.

Some example implementations of the present disclosure are listed below.

In a first aspect of the present disclosure, a method for processing data is provided. The method includes determining a reference tensor based on a tensor representing multidimensional data, where the reference tensor is associated with a target tensor. The method further includes decomposing the reference tensor to obtain multiple low-rank tensors, where a rank of each of the low-rank tensors is lower than that of the reference tensor. The method further includes determining the target tensor based on the multiple low-rank tensors so as to determine multidimensional data at a specific moment.

In some embodiments, determining the target tensor includes determining a first function based on the multiple low-rank tensors within a first time period prior to the specific moment, where the first function indicates a relationship between the determined target tensor and the reference tensor.

In some embodiments, decomposing the reference tensor to obtain multiple low-rank tensors includes performing train decomposition on the reference tensor by using a predetermined decomposition factor to generate at least two low-rank tensors; and determining the target tensor by using the at least two low-rank tensors.

In some embodiments, the method further includes determining a second function based on a difference between the determined target tensor and an actually obtained target tensor within the first time period. The method further includes minimizing the second function and updating a parameter of the second function during minimization of the second function.

In some embodiments, determining a second function includes determining a Frobenius norm based on a difference between the determined target tensor and the actually obtained target tensor, and determining an Einstein product of the Frobenius norm as the second function.

In some embodiments, the method further includes determining a nuclear norm associated with the reference tensor as an additional part of the second function.

In a second aspect of the present disclosure, an electronic device is provided. The electronic device includes a processor and a memory coupled to the processor, and the memory has instructions stored therein which, when executed by the processor, cause the device to execute actions including determining a reference tensor based on a tensor representing multidimensional data, where the reference tensor is associated with a target tensor. The actions further include decomposing the reference tensor to obtain multiple low-rank tensors, where a rank of each of the low-rank tensors is lower than that of the reference tensor. The actions further include determining the target tensor based on the multiple low-rank tensors so as to determine multidimensional data at a specific moment.

In some embodiments, determining the target tensor includes determining a first function based on the multiple low-rank tensors within a first time period prior to the specific moment, where the first function indicates a relationship between the determined target tensor and the reference tensor.

In some embodiments, decomposing the reference tensor to obtain multiple low-rank tensors includes performing train decomposition on the reference tensor by using a predetermined decomposition factor to generate at least two low-rank tensors; and determining the target tensor by using the at least two low-rank tensors.

In some embodiments, the actions further include determining a second function based on a difference between the determined target tensor and an actually obtained target tensor within the first time period. The method further includes minimizing the second function and updating a parameter of the second function during minimization of the second function.

In some embodiments, determining a second function includes determining a Frobenius norm based on a difference between the determined target tensor and the actually obtained target tensor, and determining an Einstein product of the Frobenius norm as the second function.

In some embodiments, the actions further include determining a nuclear norm associated with the reference tensor as an additional part of the second function.

In embodiments of a third aspect, an apparatus for processing data is provided. The apparatus includes a reference tensor determining module configured to determine a reference tensor based on a tensor representing multidimensional data, where the reference tensor is associated with a target tensor. The apparatus further includes a tensor decomposition module configured to decompose the reference tensor to obtain multiple low-rank tensors, where a rank of each of the low-rank tensors is lower than that of the reference tensor. The apparatus further includes a multidimensional data determining module configured to determine the target tensor based on the multiple low-rank tensors so as to determine multidimensional data at a specific moment.

In embodiments of the fourth aspect, a computer-readable storage medium is provided. The computer-readable storage medium has one or more computer instructions stored thereon, which are executed by a processor to implement the method according to the first aspect.

In embodiments of the fifth aspect, a computer program product is provided. The computer program product includes one or more computer instructions which are executed by a processor to implement the method according to the first aspect.

Although the present disclosure has been described using a language specific to structural features and/or method logical actions, it should be understood that the subject matter defined in the appended claims is not necessarily limited to the particular features or actions described above.

Rather, the specific features and actions described above are merely example forms of implementing the claims.

What is claimed is:

1. A method for processing data, comprising:
determining a reference tensor based on a tensor representing multidimensional data, wherein the reference tensor is associated with a target tensor;
decomposing the reference tensor to obtain multiple low-rank tensors, wherein a rank of each of the low-rank tensors is lower than that of the reference tensor; and
determining the target tensor based on the multiple low-rank tensors so as to determine multidimensional data at a specific moment.

2. The method according to claim 1, wherein determining the target tensor comprises:
determining a first function based on the multiple low-rank tensors within a first time period prior to the specific moment, wherein the first function indicates a relationship between the determined target tensor and the reference tensor.

3. The method according to claim 1, wherein decomposing the reference tensor to obtain multiple low-rank tensors comprises:
performing train decomposition on the reference tensor by using a predetermined decomposition factor to generate at least two low-rank tensors; and
determining the target tensor by using the at least two low-rank tensors.

4. The method according to claim 2, further comprising:
determining a second function based on a difference between the determined target tensor and an actually obtained target tensor within the first time period;
minimizing the second function; and
updating a parameter of the second function during minimization of the second function.

5. The method according to claim 4, wherein determining a second function comprises:
determining a Frobenius norm based on a difference between the determined target tensor and the actually obtained target tensor; and
determining an Einstein product of the Frobenius norm as the second function.

6. The method according to claim 5, further comprising:
determining a nuclear norm associated with the reference tensor as an additional part of the second function.

7. An electronic device, comprising:
a processor; and
a memory coupled to the processor, wherein the memory has instructions stored therein, and the instructions, when executed by the processor, cause the device to execute actions comprising:
determining a reference tensor based on a tensor representing multidimensional data, wherein the reference tensor is associated with a target tensor;
decomposing the reference tensor to obtain multiple low-rank tensors, wherein a rank of each of the low-rank tensors is lower than that of the reference tensor; and
determining the target tensor based on the multiple low-rank tensors so as to determine multidimensional data at a specific moment.

8. The electronic device according to claim 7, wherein determining the target tensor comprises:
determining a first function based on the multiple low-rank tensors within a first time period prior to the specific moment, wherein the first function indicates a relationship between the determined target tensor and the reference tensor.

9. The electronic device according to claim 7, wherein decomposing the reference tensor to obtain multiple low-rank tensors comprises:
performing train decomposition on the reference tensor by using a predetermined decomposition factor to generate at least two low-rank tensors; and
determining the target tensor by using the at least two low-rank tensors.

10. The electronic device according to claim 8, wherein the actions further comprise:
determining a second function based on a difference between the determined target tensor and an actually obtained target tensor within the first time period;
minimizing the second function; and
updating a parameter of the second function during minimization of the second function.

11. The electronic device according to claim 10, wherein determining a second function comprises:
determining a Frobenius norm based on a difference between the determined target tensor and the actually obtained target tensor; and
determining an Einstein product of the Frobenius norm as the second function.

12. The electronic device according to claim 11, wherein the actions further comprise:
determining a nuclear norm associated with the reference tensor as an additional part of the second function.

13. The electronic device according to claim 7, wherein the electronic device comprises:
a reference tensor determining module configured to determine the reference tensor based on the tensor representing multidimensional data;
a tensor decomposition module configured to decompose the reference tensor to obtain the multiple low-rank tensors; and
a multidimensional data determining module configured to determine the target tensor based on the multiple low-rank tensors so as to determine the multidimensional data at the specific moment.

14. A computer program product comprising a non-transitory computer-readable storage medium, storing one or more computer instructions thereon, wherein the one or more computer instructions are executed by a processor to implement a method for processing data, the method comprising:
determining a reference tensor based on a tensor representing multidimensional data, wherein the reference tensor is associated with a target tensor;
decomposing the reference tensor to obtain multiple low-rank tensors, wherein a rank of each of the low-rank tensors is lower than that of the reference tensor; and
determining the target tensor based on the multiple low-rank tensors so as to determine multidimensional data at a specific moment.

15. The computer program product according to claim 14, wherein determining the target tensor comprises:
determining a first function based on the multiple low-rank tensors within a first time period prior to the specific moment, wherein the first function indicates a relationship between the determined target tensor and the reference tensor.

16. The computer program product according to claim 14, wherein decomposing the reference tensor to obtain multiple low-rank tensors comprises:
performing train decomposition on the reference tensor by using a predetermined decomposition factor to generate at least two low-rank tensors; and
determining the target tensor by using the at least two low-rank tensors.

17. The computer program product according to claim 15, further comprising:
determining a second function based on a difference between the determined target tensor and an actually obtained target tensor within the first time period;
minimizing the second function; and
updating a parameter of the second function during minimization of the second function.

18. The computer program product according to claim 17, wherein determining a second function comprises:
determining a Frobenius norm based on a difference between the determined target tensor and the actually obtained target tensor; and
determining an Einstein product of the Frobenius norm as the second function.

19. The computer program product according to claim 18, further comprising:
determining a nuclear norm associated with the reference tensor as an additional part of the second function.
